(19) United States
(12) Patent Application Publication
(10) Pub. No.: US 2013/0132648 A1
(43) Pub. Date: May 23, 2013

(54) PORTABLE STORAGE DEVICE AND THE METHOD OF DYNAMICALLY ADJUSTING THE OPERATING MODES THEREOF

(71) Applicant: A-DATA TECHNOLOGY (SUZHOU) CO., LTD., SUZHOU CITY (CN)

(72) Inventors: Young-Joon Choi, TAIPEI (TW); Chi-Hao Kao, TAIPEI (TW); Yen-Hsin Liu, TAIPEI (TW)

(73) Assignee: A-DATA TECHNOLOGY (SUZHOU) CO., LTD., SUZHOU CITY (CN)

(21) Appl. No.: 13/680,115

(22) Filed: Nov. 19, 2012

(30) Foreign Application Priority Data
Nov. 18, 2011 (TW) 100142327

(51) Int. Cl. G06F 12/02

(52) U.S. Cl. CPC G06F 12/02
USPC 711/103

(57) ABSTRACT

A portable storage device includes a flash memory component, a flash memory interface coupled with the flash memory component, a host access interface coupled with the flash memory interface, and a control unit coupled between the flash memory interface and the host access interface to fetch a communication protocol of the host via the host access interface and adjust operation modes of the flash memory interface. If the transmission bandwidth of the host is no smaller than a set transmission bandwidth of the flash memory interface, the control unit controls the flash memory interface to work at a first operation mode. If the transmission bandwidth is smaller than the set transmission bandwidth, the control unit controls the flash memory interface to work at a second operation mode. The transmission bandwidth of the first operation mode is bigger than that of the second operation mode.

### BACKGROUND OF THE INVENTION

1. Field of the Invention

The present invention relates to a storage device, more particularly to a portable storage device and the control method thereof.

2. Description of Related Art

The trend of current data storage devices is toward the directions of high-capacity, compact-size, and high access data speed. Except for the storage devices which are used for storing database systems and must be fixed in a server, most users are used to store personal files or pictures in carry-on storage devices. Hence, portable storage devices are generated according to the needs from users.

Current portable storage devices usually use Hard Disk or Flash memory as cells for storing data. Hard Disk has the advantages of high-capacity, however, large volume is a problem which is not convenient for carry-on and cannot bear much shock during carry-on. Flash Drive has the advantages of compact size and easy to be carry-on and is used widely to different kinds of electronic equipments. The users could carry the portable storage devices using flash drives conveniently and exchange data with different kinds of electronic equipments.

The speed of accessing data (bandwidth) of the portable storage devices is not fixed. The portable storage device could change the access speed according to different hosts (such as: electronic equipments or personal computers). For example, the access speeds have a big difference between USB (Universal Serial Bus) 3.0 and USB 2.0. The data access speed of the access interface of the flash drive is set by manufacturers when manufacturing and usually set as relatively high bandwidth. However, high bandwidth means high operation frequency and high data latching rate. Hence, the possible issues are higher power consumption and big electromagnetic interference.

Hence, it is necessary to improve the portable storage device to address problems mentioned above.

### BRIEF SUMMARY OF THE INVENTION

Accordingly, an object of the present invention is to provide a portable storage device which is capable of adjusting operation modes thereof according to a communication protocol between the portable storage device and a host.

Another object of the present invention is to provide a method of dynamically adjusting operation modes of the portable storage device according to the communication protocol between the portable storage device and a host.

In order to achieve the above-mentioned object, a portable storage device in accordance with the present invention comprises at least one flash memory component, a flash memory interface coupled with the at least one flash memory component for accessing data from the flash memory component, a host access interface coupled with the flash memory interface for transmitting the data from the flash memory interface to a host or transmitting data from the host to the flash memory interface, and a control unit coupled between the flash memory interface and the host access interface and fetching a communication protocol of the host via the host access interface and adjusting operation modes of the flash memory interface. If the transmission bandwidth of the host is no smaller than a set transmission bandwidth of the flash memory interface, the control unit controls the flash memory interface to work at a first operation mode. If the transmission bandwidth of the host is smaller than the set transmission bandwidth, the control unit controls the flash memory interface to work at a second operation mode, wherein the transmission bandwidth of the first operation mode is bigger than that of the second operation mode.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a function schematic view of a portable storage device in accordance with the present invention; and

FIG. 2 is a flow chart of dynamically adjusting operating modes of the portable storage device in accordance with the present invention.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

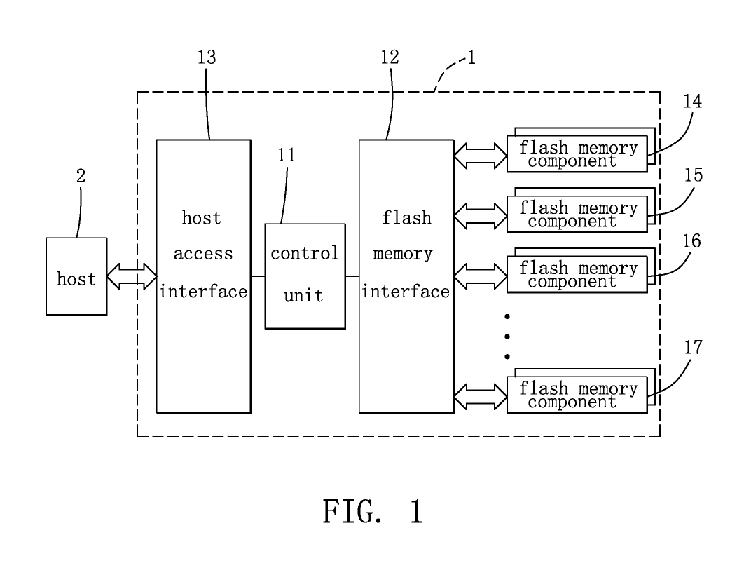

Please refer to FIG. 1, a portable storage device 1 comprises a control unit 11, a flash-memory interface 12, a host access interface 13 and a plurality of flash memory components 14˜17. The portable storage device 1 is used for exchanging data with a host 2.

The flash-memory interface 12 is coupled with the flash memory components 14˜17. The control unit 11 is coupled with both the flash-memory interface 12 and the host access interface 13. The portable storage device 1 is connected to the host 2 via the host access interface 13.

The host access interface 13 could be USB (Universal Serial Bus) 3.0, USB 2.0, SATA (Serial Advanced Technology Attachment) 2.0, SATA 3.0 or SDIO (Secure Digital Input/Output) etc.

The flash-memory interface 12 is used for accessing data to the flash memory components 14˜17. The operation modes for the flash-memory interface 12 accessing data from the flash memory components 14˜17 comprise two ways. If the transmission bandwidth provided by the host 2 is no smaller than the set transmission bandwidth of the flash-memory interface 12, the control unit 11 controls the flash-memory interface 12 to work under a first operation mode. If the transmission bandwidth provided by the host 2 is smaller than the set transmission bandwidth of the flash-memory interface 12, the control unit 11 controls the flash-memory interface 12 to work under a second operation mode. Moreover, the transmission bandwidth of the first operation mode is bigger than that of the second operation mode. For example, the first operation mode could transmit data at DDR (Double Data Rate) data latching rate. While, the second operation mode could transmit data at SDR (Single Data Rate) date latching rate. Further, the operation modes also could involve different frequencies. For example, the fist operation mode is at 133 MHz, while the second operation mode is at 100 MHz. However, it does not mean to restrict the present invention.

In the preferred embodiment of the present invention, the flash memory components 14˜17 are NAND Flash Memory which write data by Tunnel Injection means and erase data by Tunnel Release means.

The control unit 11 controls the host access interface 13 and the flash memory interface 12. The control unit 11 is usually a microprocessor chip, such as 8051 series which is only an example but not for restriction. The control unit 11 also could be other types, and will not be described here detailed.

When the host 2 needs to access the data in the portable storage device 1, the control unit 11 controls the flash memory interface 12 to fetch the data from the flash memory components 14˜17, and then controls the host access interface 13 to send the data from the flash memory interface 12 to the host 2. In other words, the control unit 11 controls the host access interface 13 to send the data from the flash memory components 14˜17 to the host 2. When the host 2 needs to send data to the portable storage device 1, the control unit 11 controls the host access interface 13 to send the data to the flash memory interface 12, and controls the flash memory interface 12 to write the data into the flash memory components 14˜17.

The control unit 11 also could detect the communication protocol of the host 2 via the host access interface 13, and dynamically adjust the operation modes of accessing data of the flash memory interface 12. The way of detecting the communication protocol of the host 2 is by hand-shaking with the host 2 via the host access interface 13. Since the data transmission speeds (bandwidth) of different communication protocols are different, when the data transmission speed between the host access interface 13 and the host 2 is slow, the control unit 11 could change the operation mode of the flash memory interface 12 or control the flash memory interface 12 to work at a relative low access speed.

The portable storage device 1 also could comprise a data temporary storage unit (not shown) which is coupled with the control unit 11 or located in the control unit 11. For example, the control unit 11 is a microprocessor which comprises a data temporary storage unit. As the portable storage device 1 accesses data, the data temporary storage unit stores the data from the host access interface 13 and the flash memory interface 12 temporarily for exchanging conveniently. Furthermore, during the data access, usually an ECC Code (Error Checking and Correcting Code) could be used for preventing error or correcting error. Hence, the data from the host access interface 13 and the flash memory interface 12 could be checked and corrected.

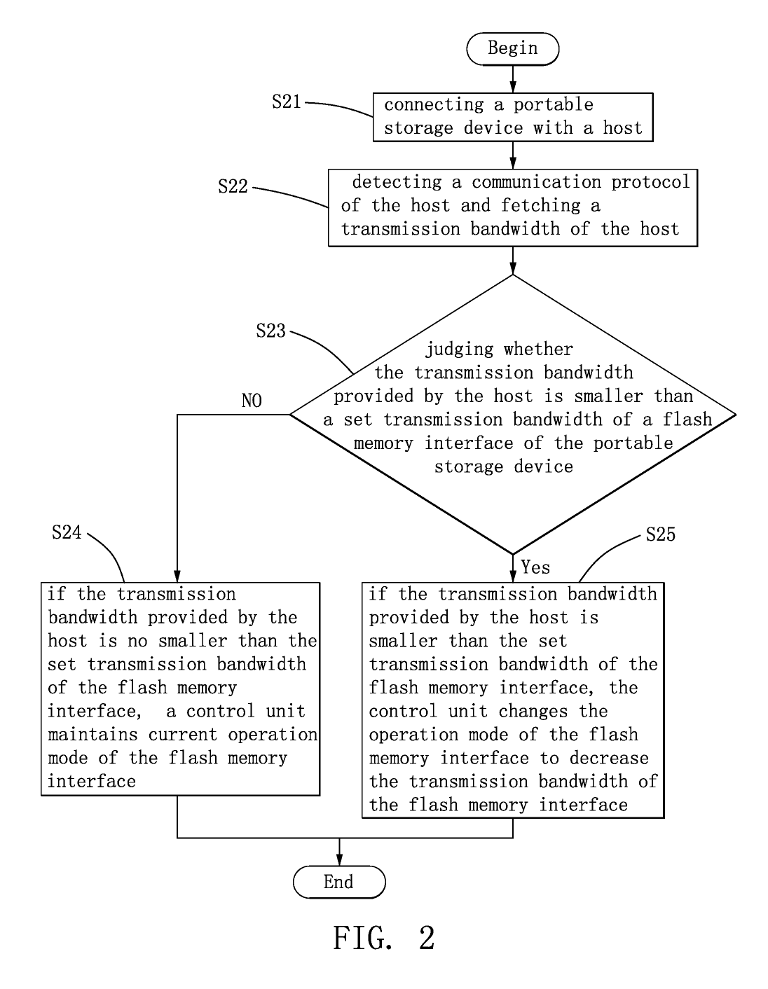

Please refer to FIG. 2 in conjunction with FIG. 1, the flow chart of the method of adjusting the operation modes of the portable storage device dynamically is disclosed. The method comprises the steps of:

S21: connecting the portable storage device 1 with the host 2.

S22: the portable storage device 1 detecting the communication protocol of the host 2 and fetching the transmission bandwidth of the host 2. The way is by hand-shaking between the host access interface 13 and the host 2.

S23: judging whether the transmission bandwidth of the host 2 is smaller than the set transmission bandwidth of the flash memory interface 12 of the portable storage device 1. Usually, the set transmission bandwidth is set as the max transmission bandwidth of the portable storage device 1. If the transmission bandwidth corresponding to the communication protocol of the host 2 is smaller than the set transmission bandwidth of the flash memory interface 12, S25 will be executed, or S24 will be executed.

S24: if the transmission bandwidth of the host 2 is no smaller than the set transmission bandwidth of the flash memory interface 12 of the portable storage device 1, the control unit 11 maintains the current operation mode of the flash memory interface 12. For example, originally, the flash memory interface 12 works at the first operation mode and at the operation frequency of 133 MHz or DDR data latching rate to transmit data, then the flash memory interface 12 maintains the current operation mode.

S25: if the transmission bandwidth of the host 2 is smaller than the set transmission bandwidth of the flash memory interface 12 of the portable storage device 1, the control unit 11 changes the operation mode of the flash memory interface 12 to lower the transmission bandwidth of the flash memory interface 12. For example, if the flash memory interface 12 works at the first operation mode with the operation frequency of 133 MHz or DDR data latching rate, then the operation mode of the flash memory interface 12 is altered from the first operation mode into the second operation mode with the operation frequency of 100 MHz or SDR data latching rate. However, this is only an example, not for restricting the present invention. In other words, the control unit 11 is capable of changing the operation modes of the flash memory interface 12.

It should be noticed that if the set transmission bandwidth of the flash memory interface 12 of the portable storage device 1 is not the max transmission bandwidth of the portable storage device 1, Step 23 should be changed as: judging the transmission bandwidth of the host 2 is bigger than the set transmission bandwidth of the flash memory interface 12 of the portable storage device 1. For example, the flash memory interface 12 could works at the first operation mode or the second operation mode which respectively correspond to a relative high transmission bandwidth or a relative low transmission bandwidth. Correspondingly, Step 24 could be changed as: if the transmission bandwidth of the host 2 is no bigger than the set transmission bandwidth of the flash memory interface 12 of the portable storage device 1, the control unit 11 maintains the current operation mode of the flash memory interface 12. Step 25 could be changed as: if the transmission bandwidth of the host 2 is bigger than the set transmission bandwidth of the flash memory interface 12 of the portable storage device 1, the control unit 11 changes the operation mode of the flash memory interface 12 to increase the transmission bandwidth of the flash memory interface 12. Hence, the power consumption is reduced and the electromagnetic Interference (EMI) is reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. A portable storage device, comprising:
at least one flash memory component;
a flash memory interface coupled with the at least one flash memory component for accessing data from the flash memory component;
a host access interface coupled with the flash memory interface for transmitting the data from the flash memory interface to a host or transmitting data from the host to the flash memory interface; and
a control unit coupled between the flash memory interface and the host access interface and fetching a communication protocol of the host via the host access interface and adjusting operation modes of the flash memory interface; wherein
if the transmission bandwidth of the host is no smaller than a set transmission bandwidth of the flash memory interface, the control unit controls the flash memory interface to work at a first operation mode, if the transmission bandwidth of the host is smaller than the set transmission bandwidth, the control unit controls the flash memory interface to work at a second operation mode, wherein the transmission bandwidth of the first operation mode is bigger than that of the second operation mode.

2. The portable storage device as claimed in claim 1, wherein detecting the communication protocol is fetched by hand-shaking between the host access interface and the host.

3. The portable storage device as claimed in claim 1, wherein the first operation mode has DDR (Double Data Rate) data latching rate, and wherein the second operation mode has SDR (Single Data Rate) data latching rate.

4. The portable storage device as claimed in claim 1, wherein the first operation mode has a first operation frequency, and the second operation mode has a second operation frequency, and wherein the first operation frequency is bigger than the second operation frequency.

5. The portable storage device as claimed in claim 4, wherein the at least one flash memory component is a NAND flash memory component.

6. The portable storage device as claimed in claim 1, wherein the host access interface is one of Universal Serial Bus (USB), Serial Advanced Technology Attachment (SATA) or Secure Digital Input/Output (SDIO).

7. The portable storage device as claimed in claim 1, further comprising a data temporary storage unit coupled with the control unit and temporally stores data from the host access interface and the flash memory interface.

8. A method of adjusting operation modes of a portable storage device dynamically, wherein the portable storage device comprises at least one flash memory component, a flash memory interface coupled with the at least one flash memory component, a host access interface adapted for connecting with a host coupled with the flash memory interface, and a control unit controlling operation modes of the flash memory interface; the method comprising the steps of:
the portable storage device detecting a communication protocol of the host and fetching a transmission bandwidth provided by the host;
judging whether the transmission bandwidth provided by the host is smaller than a set transmission bandwidth of the flash memory interface of the portable storage device;
if the transmission bandwidth provided by the host is no smaller than the set transmission bandwidth of the flash memory interface, the control unit controlling the flash memory interface to work at a first operation mode; and
if the transmission bandwidth provided by the host is smaller than the set transmission bandwidth of the flash memory interface, the control unit controlling the flash memory interface to work at a second operation mode; wherein
the transmission bandwidth of the first operation mode is bigger than that of the second operation mode.

9. The method of adjusting operation modes of a portable storage device dynamically as claimed in claim 8, wherein detecting the communication protocol of the host is fetched by hand-shaking between the host access interface and the host.

10. The method of adjusting operation modes of a portable storage device dynamically as claimed in claim 8, wherein the first operation mode has DDR (Double Data Rate) data latching rate, and wherein the second operation mode has SDR (Single Data Rate) data latching rate.

11. The method of adjusting operation modes of a portable storage device dynamically as claimed in claim 8, wherein the first operation mode has a first operation frequency, and the second operation mode has a second operation frequency, and wherein the first operation frequency is bigger than the second operation frequency.

12. The method of adjusting operation modes of a portable storage device dynamically as claimed in claim 8, wherein the at least one flash memory component is a NAND flash memory component.

13. The method of adjusting operation modes of a portable storage device dynamically as claimed in claim 8, wherein the host access interface is one of Universal Serial Bus (USB), Serial Advanced Technology Attachment (SATA) or Secure Digital Input/Output (SDIO).
